(19) United States
(12) Patent Application Publication
(10) Pub. No.: US 2005/0219224 A1
(43) Pub. Date: Oct. 6, 2005

(54) Electronic ink digitizer

(76) Inventor: Frank Liebenow, Jefferson, SD (US)

Correspondence Address: GATEWAY, INC.;ATTN: SCOTT CHARLES RICHARDSON, 610 GATEWAY DRIVE, MAIL DROP Y-04, N. SIOUX CITY, SD, 57049, US

(21) Appl. No.: 10/814,377

(22) Filed: Mar. 31, 2004

(51) Int. Cl. G09G 5/00

(52) U.S. Cl. 345/173

(57) ABSTRACT

A system and method for digitizing data written to an electronic ink display by a external device such as a stylus includes setting an element of the electronic ink display to one of a plurality of predetermined display states, modifying the display by writing to the display with the external device, and reading the electronic ink display to determine if the display state of the element has been modified by the external device.

### TECHNICAL FIELD

The present invention relates in general to electronic digitizers, and more particularly to systems, devices, and methods for detecting, writing, and reading data that has been entered to an electronic ink display with a hand held device such as a charged pen or stylus.

### BACKGROUND

A conventional digitizer or touch screen employs a sensor panel array above or behind a display device to generate signals according to where the display is touched. The signals are captured by a controller that scans the array more or less continuously, processes the signals received from the sensors and translates these signals into touch event data that can be passed to the PC's processor, usually via a serial or USB interface. The data is typically stored in a volatile display memory that is scanned many times a second to update and redraw the display. In this way the user is provided with visual feedback of what has just been drawn to the screen. The data can also be saved from the display memory to a file, if desired. Continuous scanning and redrawing of the display requires processor time, bus bandwidth and overhead related to other subsystems. If the machine is quite busy or simply slow, significant delays can occur between data entry and display updates disrupting the visual feedback needed to draw on a display screen.

### SUMMARY

In general, in one aspect, a method for digitizing data includes setting an element of an electronic ink display to one of a plurality of display states, modifying the display state of the element by writing to the display with an external device, and reading the element to determine if the display state has been modified.

In general, in another aspect, a system for digitizing data written to an electronic ink display includes means for setting an element of the electronic ink display array to one of a plurality of predetermined display states from display data stored in memory, means for modifying the display state of the element by writing to the display with an external device, means for reading the element of the electronic display to determine the display state, and means for writing the display state read for the element to memory.

In general, in another aspect, a system for digitizing data written to an electronic ink display includes an electronic ink display that provides a matrix of display elements in which a plurality of charged pigmented particles are suspended in a dielectric medium, the matrix of display elements interposed between a common electrode and a grid of addressable electrode elements, a hand-held charged device to effect display state modifications in one or more display elements of the electronic ink display, a memory to store display data representing display states for the display elements of the electronic ink display, a display driver operatively connected between the memory and the grid of addressable electrode elements to set display states of at least one display element of the electronic ink display based on the display data, and an identification and detection circuit operatively connected to the electronic ink display to determine the display state of the at least one display element of the electronic ink display.

In general, in another aspect, a program comprising a storage medium tangibly embodying program instructions for digitizing data written to an electronic ink display, includes instructions operable to cause at least one programmable processor to set an element of the electronic ink display to one of a plurality of persistent display states based on display data in memory, wait in a power down or power off mode of operation for a signal to initiate a read operation, read the element to determine the display state, and store data for the display state in the memory.

### BRIEF DESCRIPTION OF THE INVENTION

A preferred exemplary embodiment of the invention is illustrated in the accompanying drawings in which like reference numerals represent like parts throughout and in which:

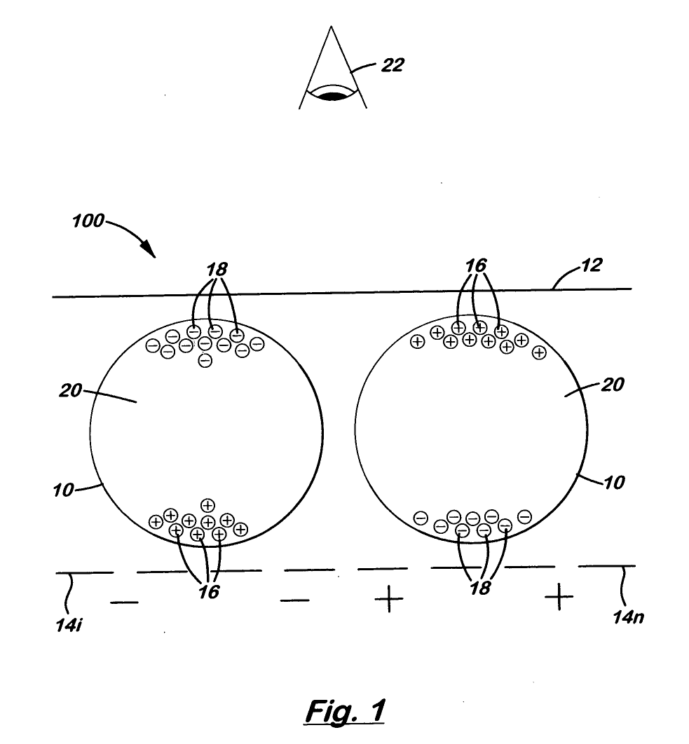

FIG. 1 shows a side sectional view of display elements of an electronic ink display according to an embodiment of the present invention;

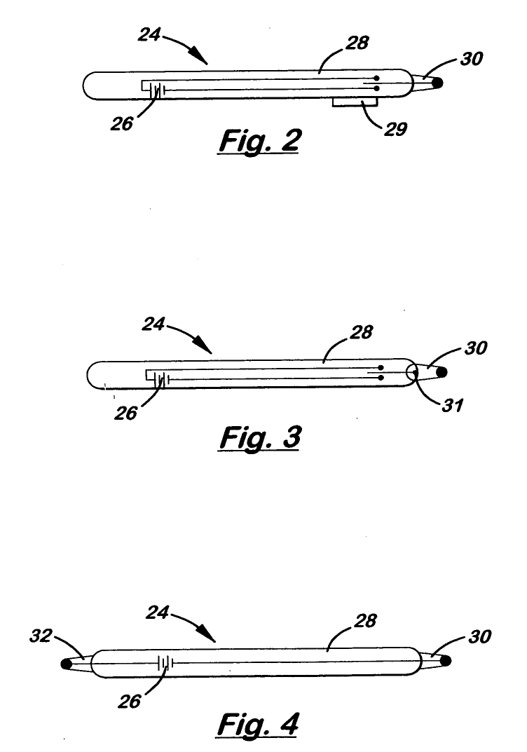

FIG. 2 shows a partial schematic diagram of a stylus for an electronic ink display according to an embodiment of the present invention;

FIG. 3 shows a partial schematic diagram of a stylus for an electronic ink display according to an embodiment of the present invention;

FIG. 4 shows a partial schematic diagram of a stylus for an electronic ink display according to an embodiment of the present invention;

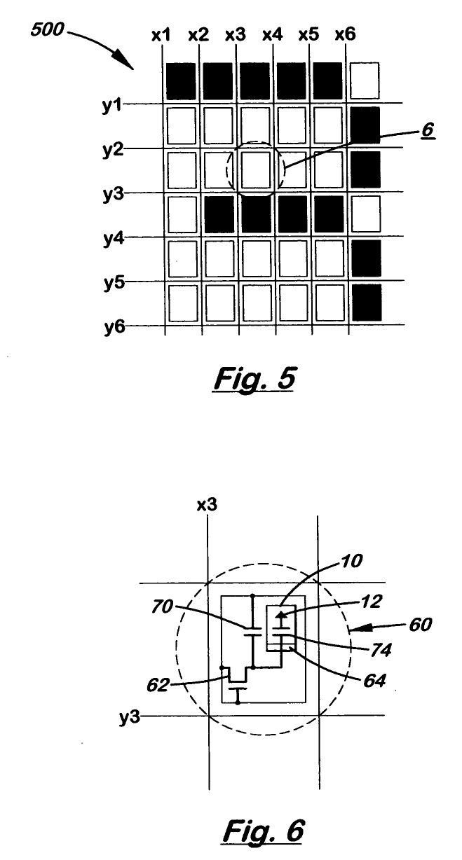

FIG. 5 shows a schematic diagram of an electronic ink display matrix for an electronic ink digitizer according to an embodiment of the present invention;

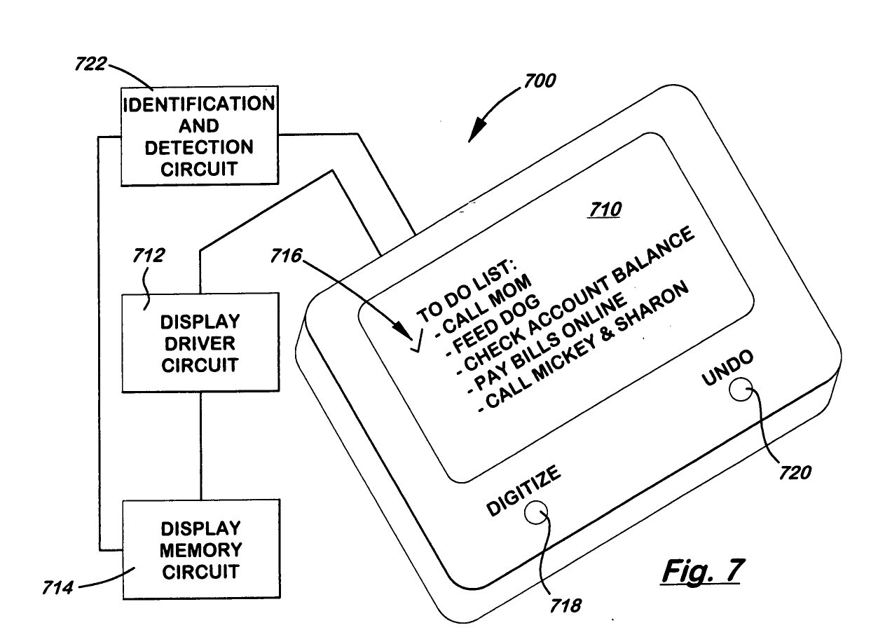

FIG. 6 shows an enlarged view of one element of an electronic ink display matrix for an electronic ink digitizer according to an embodiment of the present invention;

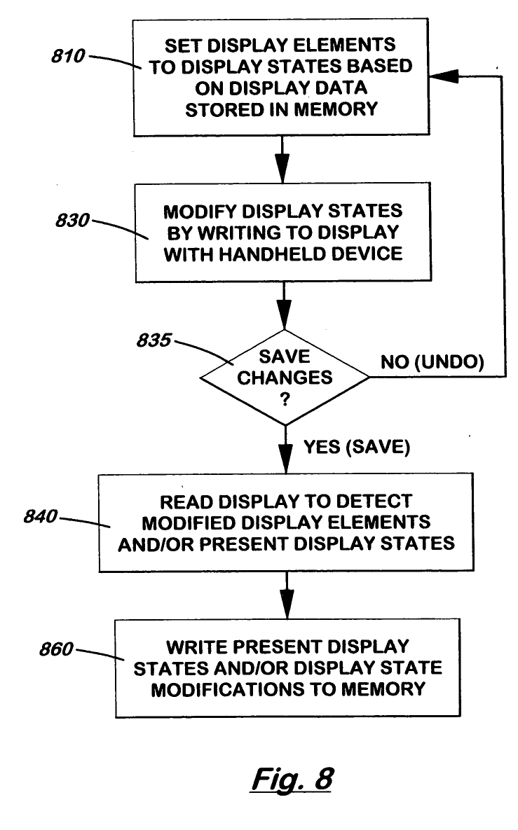

FIG. 7 shows a perspective view of an electronic ink display according to an embodiment of the present invention; and

FIG. 8 shows a simplified flow chart of the operation of a system for an electronic ink digitizer according to an embodiment of the present invention.

### DETAILED DESCRIPTION

In the following detailed description, reference is made to the accompanying drawings that form a part hereof, and in which are shown by way of illustration specific embodiments in which the invention, as claimed, may be practiced. The invention may, however, be embodied in many different forms and should not be construed as limited to the embodiments set forth; rather, these embodiments are provided so that this disclosure will be thorough and complete, and will fully convey the scope of the invention to those skilled in the art. As will be appreciated by those of skill in the art, the present invention may be embodied in systems, methods and devices.

A growing number of electronic displays are based on display elements containing charged pigmented particles that can be made to move under the influence of an applied electric field in such a way that the appearance of the display element is changed. While a wide variety of research and development efforts are underway, involving “e-ink,” “e-paper,” “e-book,” or “smart-paper,” and the like, and the technologies differ in many ways, for purposes of this disclosure, the technologies are based fundamentally on the same principles of operation, and are thus referred to collectively in this patent document as “electronic ink” displays, i.e., displays in which a change in a display state (typically involving color) can be produced by modifying the direction or intensity of an electric field to effect a rotation, movement, or migration of charged pigmented particles in a solution.

Electronic ink displays have a number of advantages. For example, electronic ink displays can be manufactured in thin flexible plastic sheets that look and feel like paper, are readable under normal lighting conditions from virtually any angle, similar to ordinary ink printed on paper, and possess inherent bistability or memory. That is, after a static image has been set by application of charges to the display elements of some electronic ink displays, the display elements will persist in the same states indefinitely under open circuit conditions. In contrast to conventional display technologies which must be continuously refreshed whether or not changes have been made to the display, maintaining a static image on such an electronic ink display typically requires little or no power. In other words, after an image such as a page from a book has been set to an electronic ink display, it can be placed in a power down or power off mode for a very long period of time and the static image will persist.

Electronic ink displays generally are formed of an array comprised of a multitude of tiny display elements or cells each containing a large number of charged pigmented particles suspended in a clear or contrastingly colored dielectric fluid. The display elements are sandwiched between a common electrode, generally transparent and in the front of the display, and individually addressable electrodes, generally in the back and usually not transparent unless the display is backlit. In one example, a thin-film transistor array, described in more detail below, may be used to address electrodes to modify the display states of selected display elements. When a charge of one polarity is applied to an electrode corresponding to a display element, the charged pigmented particles within the display element will move (or not) in a way that determines the color of the display element. For example, some electronic ink displays may contain display elements that have positively charged pigmented particles of one color and negatively charged pigmented particles of another. Setting a positive charge at the back electrode of a display element that contains positively charged black particles and negatively charged white particles, will drive the black particles to the front where they will be visible and attract the white particles to the back where they will not be visible.

Other electronic ink displays may have pigmented particles of only one color and polarity but the particles are suspended in a contrastingly colored fluid. Thus, when the particles are driven to the front of the display element, they will displace the contrastingly colored fluid and change the color displayed. In still other electronic ink displays, dipole charged beads or balls having contrasting colors on opposite sides (e.g., white/black, white/red) are contained within display elements. When a charge is applied to the display element, the beads will respond by rotating to show one side or the other depending on their polarity and the color will be determined accordingly.

One aspect of electronic ink displays recognized by the inventor, is the ability to modify the appearance of an electronic ink display with an external hand-held device such as a charged stylus. For example, by contacting the screen with a charged stylus, a voltage potential can be created between the stylus and a back electrode to effect a movement of charged pigmented particles and corresponding change in the color displayed. The changes made to the display by the charged stylus will generally remain set in the bistable display elements for a very long time. As will be seen, aspects of the present invention uniquely exploit these properties, in embodiments of electronic ink digitizers that can selectively read display states or display state modifications made to the display by an external hand-held charged device such as a stylus. (A charged device as the term is used in this application, includes a device on which the charge differs in potential, whether positive or negative, from the potential at a reference point.)

FIG. 1 shows a simplified and idealized side sectional view of two adjacent display elements 10 of an electronic ink display 100 that includes a matrix of many such display elements according to an embodiment of the present invention. Each display element 10 represents one pixel of the display and may range in size from 40-250 microns. Although the display elements 10 are illustrated as spherical, a variety of other shapes such as rectangular or oval can also be used. The display elements 10 are fixed in positioned between two generally parallel planar electrodes 12, 14. Common electrode 12 is shown at the front of the display in the direction of an observer 22 and is held at a common reference potential. Common electrode 12 is preferably made of a thin, transparent flexible conductive material such as an electro-plastic material that includes indium tin oxide (ITO). Back electrode 14, which may also be made from an electro-plastic material, is positioned behind display elements 10 and is divided into a grid of individual electrode elements 14ᵢ that are addressed through a backplane matrix of polymer (organic) electronics-based thin film transistors (TFTs) which may be fabricated from, for example, poly(ethylene terephthalate) (Mylar, 0.1 mm thick) for the substrate level and ITO (100 nm thick) for the gate level. While a passive matrix array may be employed, active matrix addressing is generally preferred since there is no inherent limitation in the number of scan lines, and they present fewer cross-talk issues than passive arrays. While the common electrode is shown in front of the display elements in alternative embodiments it may be positioned in back of the display elements.

The display elements 10, which are transparent, at least in the front, are filled with a clear fluid dielectric media 20 in which a plurality of charged pigmented particles are initially evenly dispersed in suspension by carefully balanced electrokinetics. In this example, negatively charged particles 18 are white in color and positively charged particles 16 are black.

In operation, when a rear electrode element 14ᵢ is charged negatively, positively charged particles 16 in the display element 10 above it will be attracted to the rear of the cell and negatively charged particles 18 will be driven toward the transparent front electrode 12, such that the color of the cell will appear to an observer 22 to be the color of the particles 18 (white). Applying a positive potential to a rear electrode element 14ᵢ will draw negatively charged pigmented particles 18 toward the back of the cell 10 and drive positively particles 16 toward the front electrode 12, so that the color of the positively charged particles 16 (black) will be seen by the observer 22. In some embodiments, it may be preferable to locate the common plane electrode in the back of the display to provide a more uniform reference potential for a charged hand held device contacting the front of the display.

Referring to FIG. 2-4, an elongate pen-shaped stylus 24 may be used to apply charge to the display elements 10 externally to effect changes in display states. Stylus 24 includes a contact area 30 at the tip for applying charge to the surface of an electronic ink display, an optional tether/electrical conductor 25 (not illustrated) to the electronic ink display through which may obtain power and/or a reference potential, an onboard power source 26, such as a battery and, preferably, a way to reverse the polarity of the power source so that both positive and negative charges can be applied to the display.

Various embodiments of stylus 24 will include a polarity switch 28 that is electrically connected between power source 26 and contact area 30 and which will enable the polarity of the voltage at contact area 30 to be reversed so that charged pigmented particles in display elements of the electronic ink display can be selectively attracted or repelled. For example, in the display elements illustrated in FIG. 1, the stylus 24 can be used to erase by setting polarity switch 28 to provide a positive voltage to the contact area 30. When the positively charged stylus 24 is brought in contact with the surface of the electronic ink display, black positively charged particles 16 in one or more nearby display elements 10 will be caused to move away from the front electrode 12. The stylus 24 can be used to write by setting polarity switch 28 to provide a negative voltage to the contact area 30. When the negatively charged stylus 24 is brought in contact with the electronic ink display, negatively charged particles 16 in one or more nearby display elements 10 will be caused to move toward the front electrode 12. In some embodiments of an electronic ink digitizer according to the present invention, the electronic ink display system can provide additional modes, such as “highlight” or “underline.”

The polarity switch 28 of stylus 24 can be operated in a number of different ways. In a first embodiment of stylus 24, shown in FIG. 2, the polarity switch 28 is operated manually, for example, by depressing a push button 29 on the stylus 24. A variety of other switch types such a as rocker or slide switch may also be employed.

As shown in FIG. 3, polarity switch 28 of stylus 24 may be operated automatically in response to detection of stylus movement. In this embodiment, the contact area 30 is operatively connected to a sensor 31 which detects movement of the stylus in one direction or the other and will cause the polarity switch 28 to be toggled accordingly. For example, when the stylus 24 is moved to the left, sensor 31 will cause polarity switch 28 to provide an erase voltage to contact area 30. When the stylus 24 is moved to the right sensor 31 will cause polarity switch 28 to provide a write voltage to contact area 30. Sensor 31 may include a pivotable contact area that is mechanically coupled to switch 24, so that when the stylus 24 is moved in one direction or the other, the contact area will pivot from a positive switch contact to a negative switch contact. In other embodiments, sensor 31 may include one or more mechanical, optical or electrical elements such as an accelerometer, optical tracker or other motion detection device which will generate a signal to indicate a predetermined stylus movement to operate polarity switch 28 accordingly. While polarity switch 28 is illustrated as a mechanical device, it may also be implemented using one or more electronic switching elements such as transistors or diodes in a variety of circuit configurations as would be familiar to those of skill in the art.

In a third alternative embodiment of stylus 24, shown in FIG. 4, one side of voltage supply 26 is connected to a contact area 30 and the other side to a second contact area 32 positioned on the opposite end of the stylus 24 similar to the eraser/pencil point arrangement of an ordinary pencil.

The size of the display area affected by the stylus 24 can be modified by increasing or decreasing the potential difference of the stylus the contact area which can be controlled in response to an increase or decrease in stylus pressure, for example, or by adjusting software or hardware controls or keys positioned on the stylus or display.

In alternative embodiments, movement of pigmented particles in a display of bistable elements may be effected by application of an external magnetic field or another vector field.

FIG. 5 shows a simplified schematic diagram of a 6×6 active matrix array 500 of an electronic ink digitizer according to the preferred embodiment of the present invention. An enlargement of an individual array element 60 is shown in FIG. 6. Array element 60 includes a thin film transistor TFT 62, which preferably is an organic TFT, an electronic ink display element 10, a display element electrode 64, and a storage capacitor 70. The capacitance associated with display element 10 is shown as a load capacitor 74 between the display element electrode 64 and common electrode 12 and may be connected in parallel with a storage capacitor 70. In operation, each array element 60 is addressed by selecting the appropriate data bus line xᵢ and gate bus line yᵢ. For example, array element 60 of FIG. 6 is addressed by applying a positive voltage pulse to gate electrode y₃ through a gate bus-line to turn on TFT 62. Capacitors 70 and 74 will then charge to the level of the voltage on the data bus line X₃. Capacitor 70 (which may not be required in some embodiments) is selected to maintain a field voltage on the display element electrode 64 for a sufficient time to allow the charged pigmented particles within the display element 10 to migrate into position in a set or reset operation.

Although intermolecular forces, i.e., particle-to-display-element-wall and particle-to-particle binding, will generally be much greater than particle-to-particle repulsion due to the relatively small charge per particle and will generally be sufficient to hold the charged pigmented particles in position after the field voltage has been turned off, in some embodiments where greater stability is desired a capacitor 70 may be included. Where even greater stability is needed, capacitor 70 may be fabricated to include a charge storage element such as a floating gate on which a charge can be stored indefinitely to better maintain the charged pigmented particles in position. In other embodiments, particle stability will be adequate without a storage capacitor 70 and the overall load capacitance can be minimized to improve switching speeds.

FIG. 7 shows an external perspective view of an electronic ink display 700 on which a static graphical image 710 (a “to-do” list) is displayed. Image 710 has been written to the display by a display driver circuit 712 from data stored in a display memory 714. Data 716 has also been entered to the display by the user with a conductive stylus 24, such as has been described above. After all changes and additions have been entered, the user can elect to have the changes to be digitized and entered into memory by selecting Digitize function key 718. Digitize function 718 will activate identification and detection element 722 which will perform one or more operations described in detail below to determine the present state of display elements or whether any display states have been modified from the state stored in memory. Alternatively, the user can discard the changes by selecting the Undo function key 720 which will cause the display to revert to one or more previous versions of image 710 stored in memory.

Operation of various embodiment of the present invention will now be described. FIG. 8 shows a simplified flow diagram of the operation of the preferred embodiment of an electronic ink digitizer according to the present invention. As indicated generally by function block 810, display elements 10 of the electronic ink display are initially set by a display driver circuit 712 to one of several predetermined display states from data stored in display memory 714. The data may represent graphics, text, blank forms or templates, or a blank writing slate. For example, in FIG. 7, image 710 (a simple “to do” list) is retrieved from display memory 714 and set to the electronic ink display 700 by display driver circuit 712. In general, after the image has been set to the electronic ink display, the image will persist for a very long time and the display will cycle into a sleep mode, i.e., a power down or power off mode.

Each display state of an electronic ink display element (e.g., “write,” “erase,” “select,” “highlight,” “lock,” “unlock,” etc.) can be identified by characteristics or properties that depend directly or indirectly on the distribution or orientation of charged pigmented particles within. These characteristics can be used to identify or distinguish one state from another, or to detect state changes. As will be described in detail below, identification characteristics may be based on display element properties including electrical, magnetic, optical or acoustic properties, or some combination thereof, which can be detected in a variety of destructive or non-destructive operations and used to determine, directly or indirectly, the display state of a element or whether the display state has been changed from a prior state.

After the display elements have been set, as noted above, the electronic ink display will generally be in a power down or power off mode. The user may then selectively modify the display state of one or more display element by externally applying charge to the display with a handheld device such as charged stylus 24, as indicated generally at block 830. While the display state modifications will be recorded in the bistable display elements and will be visible to the user without appreciable delay, display state changes will not be stored in display memory 714 until later, if at all.

The electronic ink digitizer will generally wait until it received a command from the user to initiate a Store procedure. In some embodiments, however, a store procedure may be initiated automatically, for example, by a timer. The electronic ink digitizer will generally also include an Undo command, indicated by the arrow from block 835 to the initial set operation of block 810, which will return the display to a previous version stored in memory 714.

The memory store procedure generally includes reading display elements to detect state changes or present display states, and updating the memory. The read operation, indicated at block 840, and discussed in detail below, involves probing the display elements to detect identification characteristics that can be used to identify present display states and/or determine display state modifications.

After the read operation has been completed and present display states or display state modifications have been determined for all the elements of the display, the memory 714 is updated to the reflect the present version of the display as indicated in block 860. More than one previous version of the display data may be retained in display memory 714, if desired.

In the preferred embodiment, reading an element of an electronic ink display in general will include performing one or more set (reset) operations on the element, measuring the current required to perform each operation and evaluating the measurements to determine the present display state of an element or to determine whether the display state of an element has been modified.

In a first example of the preferred embodiment, the read operation determines the present display state of an element. The present display state can be found by resetting the element to a predetermined reset state and measuring the current required to perform the reset operation. Performing a reset on an element that is already in the predetermined reset state will require measurably less current than a reset performed on an element that undergoes a state change. The reset current measured for each element may be thresholded or otherwise evaluated to determine the present display state. The present display states may be stored as a new version of the display in memory. User changes to the display may also be determined by comparing new and old versions of the display stored in memory or the display memory may simply be overwritten with the new version. In this example, the read operation will be destructive (i.e., the display elements will all be set to the same predetermined reset state after the display has been read) so the display will need to be restored from memory.

In another example of the preferred embodiment, the read operation will determine whether the display state of an element has been modified by resetting the element to the state stored in memory. If the display state has not been modified from the state stored in memory, the reset operation will require measurably less current than a reset performed on an element that undergoes a state change. The current required in the reset operation may be thresholded or otherwise evaluated to determine if the display state of an element has changed from the state saved in memory. The changes can then be used to update the memory. This method may be useful where it is desirable to leave the markings of the e-ink pen on the display. In such a case, if the reset operation required, for example, X current (where X indicates the amount of current required to reset a display element modified by an external force), then the modified state would be stored and the display element reset back to its modified state.

In yet another example of the preferred embodiment, the read operation will determine whether the display state of an element has been modified by resetting the element to the inverse of the state stored for that element in memory, followed by resetting the element a second time to the state saved in memory. If the display state of an element has not been modified, it should require X current to change the display element and X to change it back. In other words, if nothing external has changed the state of a display element, it should require 2X current to cycle it. If the display element has been changed, then the first rewrite operation will take less current because the display element will already be in the inverted state and the second rewrite will take X, thereby requiring less than 2X current to cycle that display element. In this example, the display element will have to be re-inverted to change it back to the state the e-ink pen left it in. This method may be useful in gathering information from a form, where the entered data is extracted and the form reset to its original state.

In some embodiments, identification characteristics will be sufficiently distinct, stable and uniform throughout a display to evaluate by a simple comparison or thresholding with fixed values. In other embodiments, models of identification characteristics will take into account a variety of environmental and process variables. For example, model identification characteristics may account for changes in temperature, pressure, supply voltage and variations in identification characteristics from display to display or display element to display element. Alternatively, the display elements can be individually probed in an initialization process to establish values for identification characteristics or to update a model of identification characteristics.

In an alternative embodiment, the read operation will include measuring one or more values related to the impedance of the display element to derive identification characteristics. For example, the display may be probed to measure the load capacitance of the display elements 10. Alternatively, identification characteristics may be derived from the resistance or inductance of a display element. Impedance measurements may be performed using the same grid used to set the display states of the display elements or by incorporating one or more dedicated measurement lines in the display. One advantage of this embodiment is that the read operation can be performed nondestructively. For example, a small signal ac voltage that is well below the write or erase voltage may be used to determine changes in impedance from one display state to another. In other examples, a DC voltage (which may be compared with a reversed DC voltage in some examples) may be used in a non-destructive read operation to probe for electrical properties to identify states or state changes.

In additional alternative embodiments, a sensor may be selectively engaged to probe for identification characteristics of individual display elements related to acoustic, optical, or electrical or magnetic properties. The sensor array may be interconnected to the display grid and accessed via one or more select lines or may be provided with one or more dedicated lines or an independently addressable grid. For example, an LED and photosensor may be employed to detect the intensity of light transmitted through a region of a display element to determine the position of pigmented particles within and used to arrive at identification characteristics. Similarly, acoustical properties of a display element will vary depending on the position of the pigmented particles. An acoustical probe may be employed to detect acoustic impedance or resonance of a display element to determine the position of pigmented particles within in order to derive identification characteristics. A radio frequency probe may also be employed in some embodiments to detect changes in electrical impedance to determine the position of pigmented particles within a display element. Similarly, a display element may be probed to detect changes in magnetic properties in some other embodiments. Such properties may be used alone or in combination with other properties to derive identification characteristics. A equivalent circuit model or a physical model of the display element impedance may be referenced in some embodiments to evaluate and measure identification characteristics.

Embodiments of digitizers according to the present invention differ from standard digitizers in that overwriting of changes to the display can be accomplished without involving the resources computing system. In a conventional digitizer, when a pen line is drawn across some text, a processor must recognize each movement of the pen and change the display under the pen quickly enough to give positive feedback to the person who is writing. Continuous scanning must be performed by a processor or controller to detect any changes. In contrast, embodiments of a digitizer according to the present invention can be designed to operate passively until the data entry process has been completed. The stylus can be used to write on the display and changes will be recorded and retained on the display without the use of the processor or controller. If the record/digitize function is not selected, the processor does not even need to know that the display is being written upon (e.g., highlighted) by the user, unless digitization is needed, and then, the processor does not need to re-write the display as is typically required with existing digitizer technology.

Embodiments of the present invention will find application in a variety of systems and devices where an electronic display that can be modified in appearance with a suitable hand-held charged device is useful. For example, the present invention can be embodied in a an electronic-ink book, a rewritable electronic business form or a writing tablet, a cash register, automated teller machine, or digitizing pad such as used to record a signature, a tablet computer or notebook, personal digital assistant (PDA), a cellular telephone, a calculator, a DVD player, a digital camera or camcorder, and a variety of other systems and devices.

### Conclusion

A number of embodiments of the invention defined by the following claims have been described. Nevertheless, it will be understood that various modifications to the described embodiments may be made without departing from the spirit and scope of the claimed invention. For example a variety of circuitry and components may be implemented in software, firmware, hardware, or combinations thereof. Accordingly, other embodiments are within the scope of the invention, which is limited only by the following claims.

1. A method for digitizing data, comprising:
setting an element of an electronic ink display to one of a plurality of display states;
modifying the display state of the element by writing to the display with an external device; and
reading the element to determine if the display state has been modified.

2. The method of claim 1, wherein the external device comprises a hand held charged device.

3. The method of claim 1, wherein reading the element to determine if the display state has been modified comprises detecting an electrical property related to the display state of the element.

4. The method of claim 1, wherein reading the element to determine if the display state has been modified comprises measuring the electrical current required to reset the element to a predetermined display state.

5. The method of claim 3, wherein the electrical property comprises an impedance.

6. The method of claim 3, wherein the electrical property comprises a capacitance.

7. The method of claim 3 wherein the electrical property comprises an electrical current.

8. The method of claim 3, wherein the electrical property is detected, at least in part, by application of a probe signal.

9. The method of claim 1, wherein reading the element to determine if the display state has been modified comprises measuring the current required to reset the element to a display state stored for the element in memory.

10. The method of claim 1, wherein reading the element to determine if the display state has been modified comprises measuring the current required to set the element to a display state that represents the inverse of a display state stored for the element in a memory followed by resetting the element to a display state stored for the element in the memory.

11. The method of claim 1 wherein the display state of the element is sustained in a power down or power off mode of the electronic ink display after the element has been set.

12. The method of claim 1 wherein reading the element to determine if the display state has been modified comprises referring to one or more models.

13. The method of claim 1, wherein reading the element to determine if the display state has been modified is performed using a grid that is also used in setting the element.

14. A method of digitizing data, comprising:
setting an element of a display comprised of bistable display elements to one of a plurality of predetermined display states wherein the display state of the element persists in a power down or power off mode of the display after the element has been set;
modifying the display state of the display element with an external device; and
reading the display element to detect the display state.

15. The method of claim 14 further comprising updating a display memory with the display state.

16. The method of claim 14 further comprising determining whether the display state has been modified by the external device.

17. The method of claim 14 wherein reading the element of the display to obtain a display state comprises resetting the element to a predetermined reset state and measuring the current required to perform the reset operation.

18. The method of claim 14, wherein reading the element of the display to obtain a display state is performed on a grid that is also used in setting the element.

19. The method of claim 14, wherein reading the element of the display to obtain a display state comprises probing to detect an electrical property of the element.

20. The method of claim 19, wherein the electrical property comprises an impedance.

21. The method of claim 19, wherein the electrical property comprises a capacitance.

22. The method of claim 19, wherein the electrical property is determined, at least in part, by application of a small signal alternating current to the display element.

23. The method of claim 19 wherein the display state is determined, at least in part, by reference to a model.

24. The method of claim 23 wherein the model accounts for variables comprising environmental variables.

25. The method of claim 23 wherein the model accounts for variables comprising process variables.

26. A system for digitizing data written to an electronic ink display, comprising:
means for setting an element of the electronic ink display array to one of a plurality of predetermined display states from display data stored in memory;
means for modifying the display state of the element by writing to the electronic ink display with an external device;
means for reading the element of the electronic display array to determine the display state; and
means for writing the display state read for the element to memory.

27. A system for digitizing data written to an electronic ink display, comprising:
an electronic ink display that includes an array of display elements in which a plurality of charged pigmented particles are suspended in a dielectric medium, the array of display elements interposed between a common electrode and a grid of addressable electrode elements;
a hand-held charged device to effect display state modifications in one or more display elements of the electronic ink display;
a memory to store display data representing display states for the display elements of the electronic ink display;
a display driver operatively connected between the memory and the grid of addressable electrode elements to set display states of at least one display element of the electronic ink display based on the display data; and
an identification and detection circuit operatively connected to the electronic ink display to determine the display state of the at least one display element of the electronic ink display.

28. The system of claim 27, wherein the identification and detection circuit is operatively connected to the grid of individually addressable electrode elements to which the display driver circuit is also operatively connected.

29. The system of claim 27 wherein the identification and detection circuit comprises a circuit to measure an electrical current required to perform one or more set operations by the display driver.

30. A program comprising a storage medium tangibly embodying program instructions for digitizing data written to an electronic ink display, the program instructions including instructions operable to cause at least one programmable processor to:
set an element of the electronic ink display array to one of a plurality of persistent display states based on display data in memory;
wait in a power down or power off mode of operation for a signal to initiate a read operation;
read the element to determine the display state; and
store data for the display state read in the memory.

31. The program of claim 30 wherein the read operation comprises detecting an electrical property related to the display element.

32. The program of claim 30 wherein the read operation comprises measuring the electrical current required to reset the element to a predetermined display state.

33. The program of claim 30 wherein the read operation comprises measuring the current required to reset the element to a display state stored for the element in memory.

34. The program of claim 30 wherein the read operation comprises measuring the current required to set the element to a display state that represents the inverse of a display state stored for the element in memory followed by resetting the element to the display state stored for the element in the memory.
